(19) United States
(12) Patent Application Publication
(10) Pub. No.: US 2006/0082992 A1
(43) Pub. Date: Apr. 20, 2006

(54) Rechargeable halogen searchlight with LED & fluorescent light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/067,770

(22) Filed: Feb. 28, 2005

(30) Foreign Application Priority Data
Oct. 16, 2004 (HK) 04108026.7

(51) Int. Cl. F21L 4/02; F21L 4/04; F21V 21/30

(52) U.S. Cl. 362/184; 362/190; 362/228; 362/427

(57) ABSTRACT

The present invention is relates to a rechargeable halogen search light and more particularly, to a rechargeable halogen search light which is having an ability to light up 1.5 km radius and with the strength equal to 1,500,000 candles, with ten light sources, wherein, eight of them are LEDs and a fluorescent light; equip with a handle and supporting leg. Said supporting leg moves relatively and interactively between position one and position two. If both said supporting legs are adjusted to an angle within 270°, user may place said light on a flat surface to provide long distance lighting. The present invention is an important source of light used in marine, army, public security, firefighting, emergency treatment, disciplined troop, architecture and civil vessels, as well as emergency treatment in daily life.

### REFERENCED APPLICATION

The applicant prays to cite a cross reference by his own application which was filed on Feb. 26, 2005 with an application Ser. No. 11/051,401 now pending.

### BACKGROUND OF SAID PRESENT INVENTION

1. Field of Invention

The present invention is relates to a rechargeable halogen search light and more particularly, to a rechargeable halogen search light which is having an ability to light up 1.5 km radius and with the strength equal to 1,500,000 candles, equip with a handle and two supporting legs. Said two supporting legs may move relatively and interactively between position one and position two. If both said supporting legs are adjusted to an angle within 270°, user may place said light on flat surface to provide long distance lighting.

2. Description of Related Arts

Military, law enforcement, fire and rescue personnel, security personnel, hunters and recreational boaters among others for nighttime surveillance in any application commonly use handheld halogen searchlights, where a high intensity spotlight is required. Nowadays, such application is highly demeaned in all anti-terrorists actions that take place at nighttime. Conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. The mounting is a tripod mount so that the portable searchlight may be fixed in the field to a tripod with the second device. The mounting on the handle is a thumbscrew mount to permit mounting of an optical detection device onto the searchlight and rigidly fixed to the housing. However, this lantern provide without no ability to move any angle to obtain a better light range.

### SUMMARY OF SAID PRESENT INVENTION

The main object of the present invention is to provide a rechargeable halogen search light having a supporting means and such supporting means can provide an ability to rotate an angle within 270 degree so as to sit on a flat surface.

Another object of the present invention is to provide a rechargeable halogen search light having a supporting means and such supporting mean can provide an ability to rotate and/or to move any angles within 270 degree circular arc.

Another object of the present invention is to provide a rechargeable halogen search light having an ability to adopt difference power source supplies.

Another object of the present invention is to provide a rechargeable halogen search light having a supporting means and such supporting mean can provide an adjustable mean with a tight or loose positions so as to controlling such supporting legs in a locked position or in a rotating position to reach the best lighting range and lighting angles.

Another object of the present invention is provide a rechargeable halogen search light having seven sources of lighting enable extra strength of lights.

Accordingly, to achieve the above objects, a rechargeable compact fluorescent comprises:
a three-dimensional rectangular-cylinder housing, inside of it contains at least ten sources of lighting wherein nine of said sources of lighting are LED, power saving illuminants; and
at least one of said the light sources is fluorescent light; and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it; and
a plurality supporting means and such supporting mean can provide an ability to rotate and/or to move any angles within 270 degree circular arc so as to provide a platform for user to place said light on a flat surface and/or to adjust a best angle of lighting according to appropriated situation.

### BRIEF DESCRIPTION OF SAID DRAWINGS

FIG. 1 is a side view of the present invention.

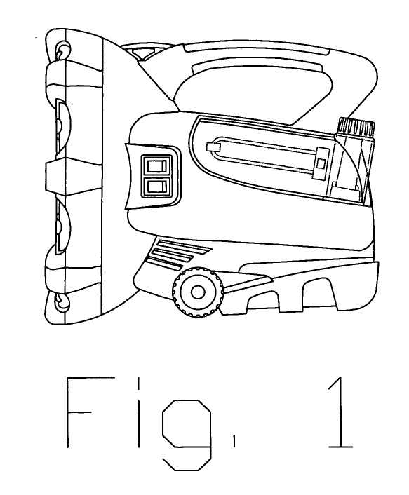

FIG. 2 is a side sectional view thereof.

FIG. 3 is a plan view thereof.

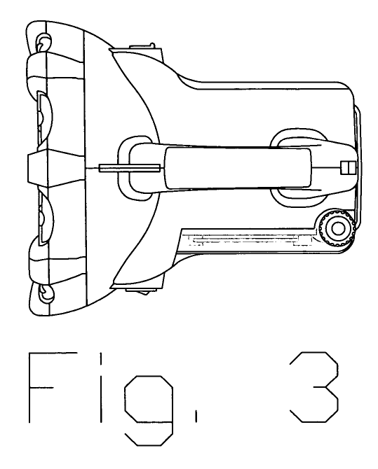

FIG. 4 is an underneath view thereof.

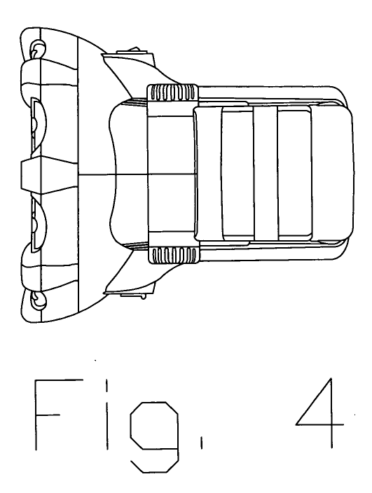

FIG. 5 is a front view thereof.

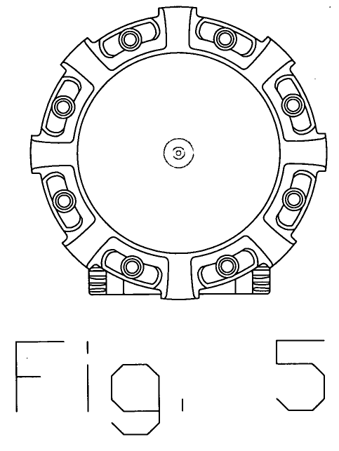

FIG. 6 is a rear view thereof.

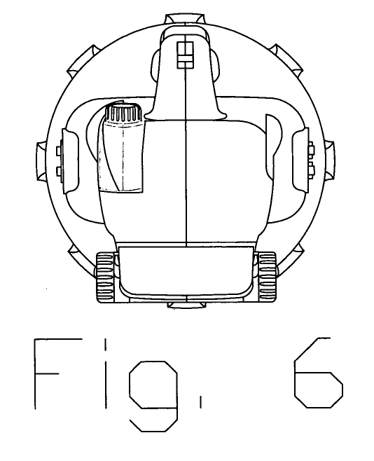

FIG. 7 is another side view thereof.

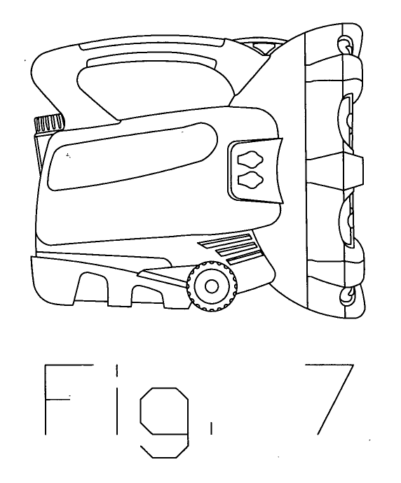

FIG. 8 is an assembly view thereof.

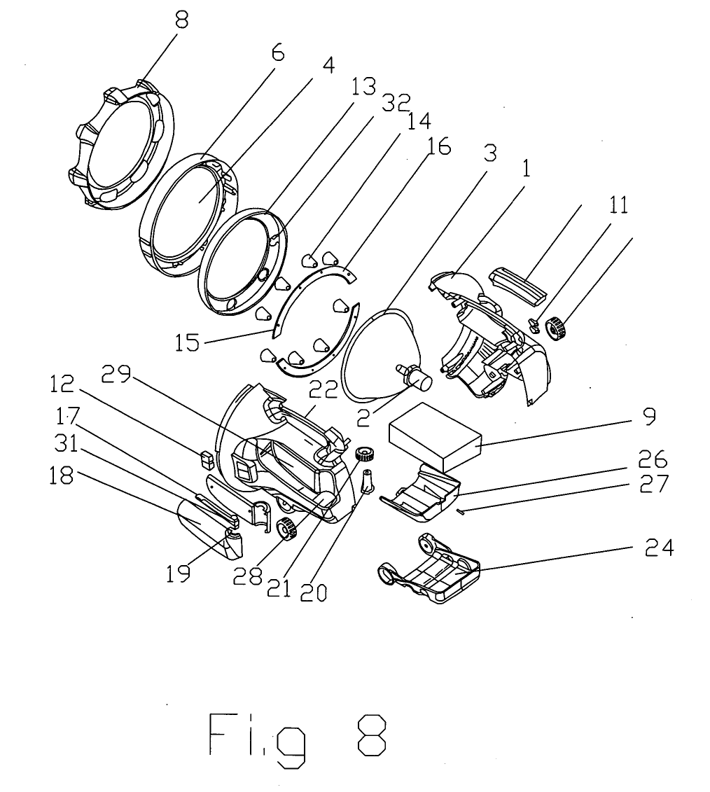

FIG. 9 is a front isometric view thereof.

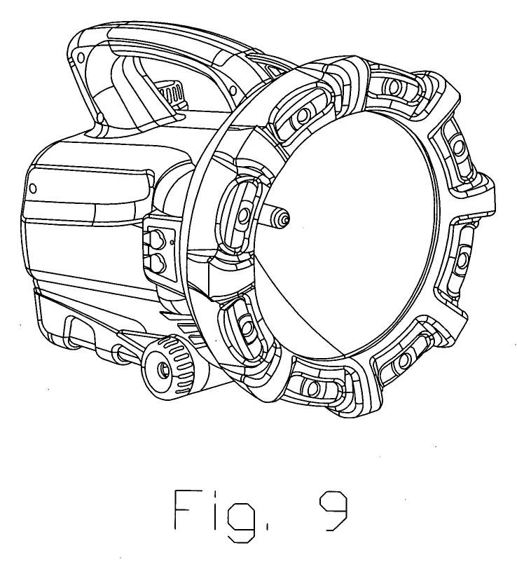

FIG. 10 is a rear isometric view thereof.

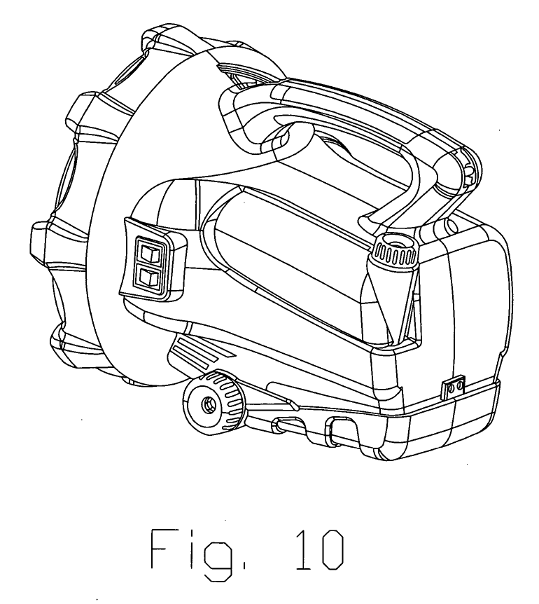

FIG. 11 is a right rear isometric view thereof.

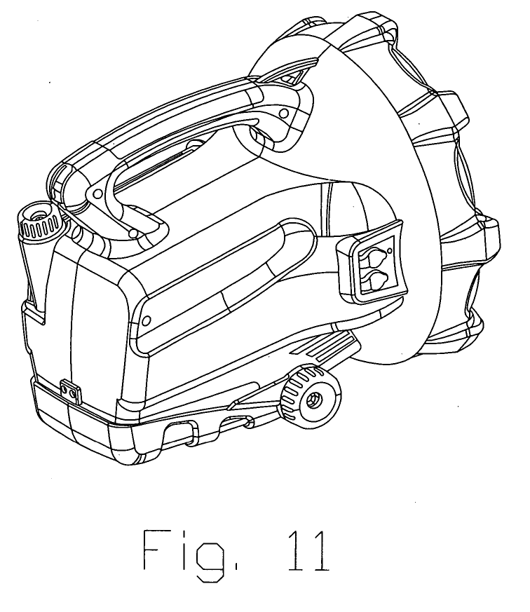

FIG. 12 is a plan view with fluorescent light showing thereof.

### DETAILED DESCRIPTION OF SAID PREFERRED EMBODIMENT

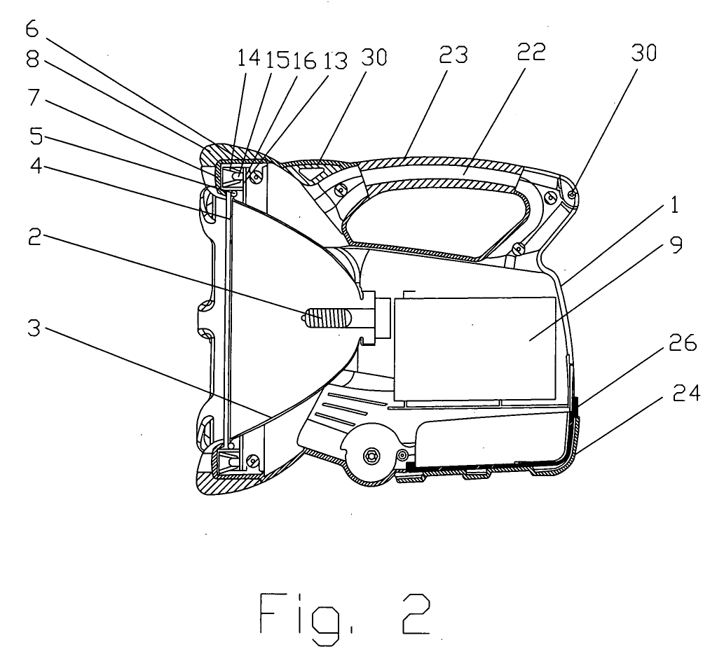

Referring FIG. 2, this rechargeable halogen searchlight with LED and fluorescent light comprises a three-dimensional rectangular-cylinder housing (1). Inside said illuminant (1), there is a light source (2), a parabola reflector (3), and a transparent front panel (4). By a sealing washer (5), said front panel (4) is sealed to end portion of said reflector (3) within a front annular head (6) from inside. Said annular head (6) is fastened to a front end of said detachable heat-release cover (24) and there are eight convex lenses (7) thereby. Said eight convex lenses are affixed with a annular head (6) and LED (15) integrally. Said LED (15) is mounted to a surface of a circuit board (16). On the surface of said annular head (6) in front of said light source (2), there is an annular lightening elastic protection head (13) enables a photoelectric source searchlight to absorb any shocks from outside.

As illustrated in figures, said light source (2) comprises of an energy-saving halogen bulb, a power source (9) provide necessary power to generate said light source (2) through a socket (11) which is taking electricity from any plugs to a power circuit (10). There is also a switch (12) mechanism connecting said power circuit (10) and said light source (2). Said power circuit (10) allows regular batteries, rechargeable batteries, and any 12 volts power generated by vehicles to supply power in lieu of wall plug-in.

Said light source (2) is powered by said power source (9) of said light source (2). A power connects to an electric circuit device (10) inside said light source (2), an external socket (9), a switch (10) and said connected energy-saving light bulb through a power line. Said power source (9) is installed inside of a battery protection box (26). Inside of said battery protection box (26), there is a metal stand supporting said power source (9) thereby protecting said power source (9) from any outside shocks.

There is a handle (22) mounted at the top portion of said housing (1). Underneath of said handle (22) there is a handled bar (23) with resilient padding to provide comfort when holding this searchlight. At both ends of said handle (11), there are two latches (30) provided for a detachable belt.

An adjustable supporting stand (24) is adjustablely mounted with said housing (1). There is an adjustable control (25) provides locking and unlock positions for said long stand (12). Said supporting stand (24) can pivot around a hinge and remain at any position within the 270° arc, so as to provide a support for said housing (1) on a flat surface to achieve a optimal lighting angle.

There is a metal screw (27) provides a locking mean to a battery protection box (26) located at the end portion of said housing (1). By pushing a release screw (27) of said battery protection box (26), said metal screw (27) thereby detach from battery protection box (26) and therefore, batteries can be replaced as needed.

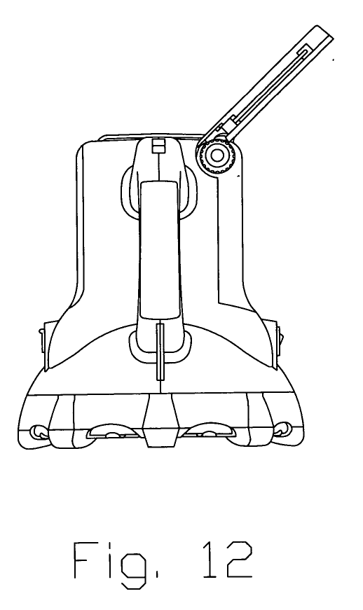

As shown in FIG. 12, at the rear portion of said housing (1), there is a fluorescent light (17) place inside a smaller housing and is connected adjustablely as a tenth light source of said light source (2). Said fluorescent light (17) is affixed in a center portion of a transparent light cover (18). There is a proactive power circuit device (31) installed at an end portion of said fluorescent light (17) and connecting said fluorescent light (17) integrally. Said transparent light cover (18) prosing a hold (19) at its end portion. Said hold (19) is adjustablely engage into a rotating pivot device (20) with engaging and non-engaging positions. There is a lock (21) installed at a top portion of said rotating pivot device (20) providing a locking mean to said light cover (18) so as to said light cover (18) can stays at a engaging position within said rotating pivot device (20). In other words, said light cover (18) provide a interchangeable positions between engaging and non-engaging poses along with any given spot of said rotating pivot device (20) with locking or without locking mean. If user places this searchlight in a vertical position on a flat surface, said fluorescent light can replace any desk lamp. Said rotating pivot device is connected and placed within a chamber (28) with a predetermined size and sharp along the edge of said housing (1). At position one, said light cover (18) can be place at a surface (29) of said chamber (28).

This rechargeable halogen searchlight with LED and fluorescent light is an important source of lighting mean employed in marine, army, public security, firefighters, emergency treatments, disciplined troops, architecture and civil vessels, as well as for emergency treatment in daily life.

What is claimed is:

1. A rechargeable halogen searchlight with LED and fluorescent light, comprises:
a three-dimensional rectangular-cylinder housing, inside of it contains at least ten sources of lighting wherein eight of said sources of lighting are LED, power saving illuminants; and
at least one of said the light sources is fluorescent light and placed inside of a smaller housing; and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it; and
a plurality of transparent light covers with holds at its end portion, and a rotating pivot device connecting a housing for fluorescent light. Said holds are adjustablely engage into a rotating pivot device with engaging and non-engaging positions.
a plurality of supporting means and such supporting mean can provide an ability to rotate and/or to move any angles within 270 degree circular arc so as to provide a platform for user to place said searchlight on a flat surface and/or to adjust a best angle of lighting according to appropriated situation.

2. A rechargeable halogen searchlight with LED and fluorescent light comprises:
a rectangular housing, inside of it contains at least ten lighting sources wherein eight of said lighting sources are LED; and
at least one of said the light sources is fluorescent light and placed inside of a smaller housing; and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it; and
a plurality of transparent light covers with holds at its end portion, and a rotating pivot device connecting a housing for fluorescent light. Said holds are adjustablely engage into a rotating pivot device with engaging and non-engaging positions.
a plurality of supporting means and such supporting mean can provide an ability to rotate and/or to move any angles within 270 degree circular arc so as to provide a platform for user to place said searchlight on a flat surface and/or to adjust a best angle of lighting according to appropriated situation.

3. A rechargeable halogen searchlight with LED and fluorescent light as recited in claim 1, wherein, said rechargeable halogen searchlight with LED and fluorescent light is further comprises:
at least one energy-saving light bulb, and
at least eight LED, and
at least one of said the light sources is fluorescent light and placed inside of a smaller housing; and
a plurality of light covers with hold at a center end portion, and
a plurality of rotating pivot device, and
at least one rotating pivot device, and
at least one arc shaped reflector,
at least one set of main switch,
at least one power receptacle for external electricity,
at least one transformer, and
at least one set of circuitry and power supply.

4. A rechargeable halogen searchlight with LED and fluorescent light as recited in claim 1, wherein said supporting means can provide an adjustable mean with a tight or loose positions so as to controlling such supporting legs in a locked position or in a rotating position to reach the best lighting range and lighting angles through said attached hinge to any position within 270 degrees circular ark. Said stands can move relatively and interactively between position one and position two allowing tightly affixed at any position to provide an adjustable lighting angle, said supporting legs provide a support on plane surface for to provide a distance lighting mean with any angle over 90°, Said stands provide supports for said housing.

5. A rechargeable halogen searchlight with LED and fluorescent light as recited in claim 1, wherein, at the rear portion if said housing, there is at least a fluorescent light place inside a smaller housing and is connected adjustablely as a tenth light source of said light source. Said fluorescent light is affixed in a center portion of a transparent light cover. There is a proactive power circuit device installed at an end portion of said fluorescent light and connecting said fluorescent light integrally. Said transparent light covers have holds at its end portion. Said hold is adjustablely engage into a rotating pivot device with engaging and non-engaging positions. There is a lock installed at a top portion of said rotating pivot device providing a locking mean to said light cover so as to said light cover can stays at a engaging position within said rotating pivot device.
In other words, said light cover provide a interchangeable positions between engaging and non-engaging poses along with any given spot of said rotating pivot device with locking or without locking mean. If user places this searchlight in a vertical position on a flat surface, said fluorescent light can replace any desk lamp. Said rotating pivot device is connected and placed within a chamber with a predetermined size and sharp along the edge of said housing. At position one, said light cover can be place at a surface of said chamber

6. A rechargeable halogen searchlight with LED and fluorescent light as recited in claim 1, wherein, said rechargeable halogen searchlight with LED and fluorescent light comprises at least ten lighting sources, which is having a energy saving fluorescent light and eight LED, said seven lighting sources are located on a light base. Electricity is provided by a power source within said housing. Electricity current goes through power cord to the insides of electrical circuitry of said housing and transformer, while connects power receptacle, on/off switch, and links up with energy saving florescent bulb.

7. A rechargeable halogen searchlight with LED and fluorescent light as recited in claim 1, wherein, said rechargeable halogen searchlight with LED and fluorescent light is further comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach the best lighting range and lighting angles; and having a long stand which can move relatively and interactively between position one and position two allowing tightly affixed at any position to provide an adjustable lighting angle, said supporting legs provide a support on plane surface for to provide a distance lighting mean with any angle within 270° providing means of support for said housing in a horizontal position to get the best lighting angle, and
having a handle attached to said housing providing mean of carrying.

8. A rechargeable halogen searchlight with LED and fluorescent light as recited in claim 1, wherein, said rechargeable halogen searchlight with LED and fluorescent light is further comprises:
a handle in a rectangular shape is longitudinally attached to said housing. A front and rear of the handle are equipped with stripes so as to provide a mean of carrying, and
a plurality of latches are provided at both end of said handle.

9. A rechargeable halogen searchlight with LED and fluorescent light as recited in claim 2, wherein, said stands can provide an adjustable mean with a tight or loose positions so as to controlling such supporting legs in a locked position or in a rotating position to reach the best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said stands provide supports for said housing.

10. A rechargeable halogen searchlight with LED and fluorescent light as recited in claim 2, wherein, said rechargeable halogen searchlight with LED and fluorescent light is, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

11. A rechargeable halogen searchlight with LED and fluorescent light as recited in claim 2, wherein, said rechargeable halogen searchlight with LED and fluorescent light is comprises a lighting source, has an energy saving halogen light bulb, which is located on a light base. Electricity is provided by a power source within said housing. Electricity current goes through power cord to the insides of electrical circuitry of said housing and transformer, while connects power receptacle, on/off switch, and links up with energy saving halogen bulb.

12. A rechargeable halogen searchlight with LED and fluorescent light as recited in claim 2, wherein, said rechargeable halogen searchlight with LED and fluorescent light t can draw electricity either from AC power outlet provided from public utility or from the chargeable heat release directly.

13. A rechargeable halogen searchlight with LED and fluorescent light as recited in claim 2, wherein, said rechargeable halogen searchlight with LED and fluorescent light is further comprises:
a handle in a rectangular shape is longitudinally attached to said housing. A front and rear of the handle are equipped with stripes so as to provide a mean of carrying, and
a plurality of latches are provided at both end of said handle.

14. A rechargeable halogen searchlight with LED and fluorescent light as recited in claim 2, wherein, said rechargeable halogen searchlight with LED and fluorescent light is further comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach the best lighting range and lighting angles; and
having a long stand which can move relatively and interactively between position one and position two allowing tightly affixed at any position to provide an adjustable lighting angle, said supporting legs provide a support on plane surface for to provide a distance lighting mean with any angle over 90°, and
said long stand can also provide rotating positions through said adjustable hinge to any position within 270 degrees circular arc, and
having a short stand which can move relatively and interactively between position one and position two allowing tightly affixed at any position to provide an adjustable lighting angle, said supporting legs provide a support on plane surface for to provide a distance lighting mean with any angle over 90°, and
said short stand can also provide rotating positions through said adjustable hinge to any position within 270 degrees circular arc,
They provide support for said housing in a horizontal position to get the best lighting angle, and
having a handle attached to said housing providing mean of carrying.

15. A rechargeable halogen searchlight with LED and fluorescent light as recited in claim 2, wherein, said rechargeable halogen searchlight with LED and fluorescent light is further comprises:
at least one energy-saving light bulb, and
at least eight LED
at least one arc shaped reflector,
at least one set of main switch,
at least one power receptacle for external electricity,
at least one transformer, and
at least one fluorescent light, and
at least one rotating pivot device, and
at least one set of circuitry and power supply.

16. A rechargeable halogen searchlight with LED and fluorescent light as recited in claim 2, wherein, said supporting means can provide an adjustable mean with a tight or loose positions so as to controlling such supporting legs in a locked position or in a rotating position to reach the best lighting range and lighting angles through said attached hinge to any position within 270 degrees circular ark. Said stands can move relatively and interactively between position one and position two allowing tightly affixed at any position to provide an adjustable lighting angle, said supporting legs provide a support on plane surface for to provide a distance lighting mean with any angle over 90°, Said stands provide supports for said housing.

17. A rechargeable halogen searchlight with LED and fluorescent light as recited in claim 1, wherein, said rechargeable halogen searchlight with LED and fluorescent light is further comprises:
at east one battery protection box, and
a plurality of metal screw provides a locking mean to a battery protection box. By pushing a release screw of said battery protection box, said metal screw thereby detach from battery protection box and therefore, batteries can be replaced as needed.

18. A rechargeable halogen searchlight with LED and fluorescent light as recited in claim 2, wherein, said rechargeable halogen searchlight with LED and fluorescent light is further comprises:
at east one battery protection box, and
a plurality of metal screw provides a locking mean to a battery protection box. By pushing a release screw of said battery protection box, said metal screw thereby detach from battery protection box and therefore, batteries can be replaced as needed
